(19) United States
(12) Patent Application Publication
(10) Pub. No.: US 2010/0079366 A1
(43) Pub. Date: Apr. 1, 2010

(54) METHOD OF DRIVING A BACKLIGHT MODULE AND A DISPLAY

(75) Inventors: Wen-Tsung LIN, Tainan County (TW); Yung-Yu TSAI, Tainan County (TW); Yu-Yeh CHEN, Tainan County (TW); Feng-Sheng LIN, Tainan County (TW)

Correspondence Address: LOWE HAUPTMAN HAM & BERNER, LLP, 1700 DIAGONAL ROAD, SUITE 300, ALEXANDRIA, VA, 22314, US

(73) Assignee: CHI MEI OPTOELECTRONICS CORP., Tainan County (TW)

(21) Appl. No.: 12/472,830

(22) Filed: May 27, 2009

(30) Foreign Application Priority Data
Sep. 30, 2008 (TW) 97137584

(51) Int. Cl. G09G 3/36

(52) U.S. Cl. 345/102

(57) ABSTRACT

In a backlight module of a display device, a first light source, a second light source, and a third light source are respectively and sequentially in a first sub-frame period, a second sub-frame period, and a third sub-frame period of a frame period so that the backlight module emits predominantly the first color light, the second color light, and the third color light during the first sub-frame period, the second sub-frame period, and the third sub-frame period, respectively. At least one of the second and third light sources also emits the second or third color light during a part of the first sub-frame period.

### RELATED APPLICATIONS

This application claims priority to Taiwan Application Serial Number 97137584, filed Sep. 30, 2008, which is herein incorporated by reference in its entirety.

### BACKGROUND

The disclosure relates to a method of driving a backlight module and the application thereof, and more particularly, to a method of driving a backlight module of a color sequential liquid crystal display.

Liquid crystal displays play an important role in modern life, emphasizing the advance of the display technology. Liquid crystal displays can be classified into two categories: traditional liquid crystal displays with color filters, and color sequential liquid crystal displays with no color filter.

In the traditional liquid crystal displays with color filters, each pixel of the traditional liquid crystal display includes three sub-pixels, which correspond to red, green, and blue color filters, respectively. The light provided by a backlight source of the traditional liquid crystal display can be filtered by the color filters to produce red, green, and blue lights in each pixel, and gray levels of the red, green, and blue lights can be adjusted by liquid crystals of the pixel, thereby displaying color images.

FIG. 1 is an exploded, perspective, schematic view of a color sequential liquid crystal display 10 of a type known to the inventors. FIG. 2 is an exploded, perspective, schematic view of a liquid crystal panel 16 shown in FIG. 1. The color sequential liquid crystal display 10 includes a backlight module 12, a light guide plate 14, and the liquid crystal panel 16, wherein the liquid crystal panel 16 includes common electrodes 16a, a liquid crystal layer 16b, pixel units 16c, a source driver 16d and a gate drivers 16e. Each of the pixel units 16c corresponds to one of red light sources 12a, one of blue light sources 12b, and one of green light sources 12c. The color sequential liquid crystal display 10 sequentially displays a red image, a blue mage, and a green image in each frame period, whereby the color sequential liquid crystal display 10 can display color images due to the persistence of vision phenomenon.

Because the color sequential liquid crystal display can display various colors without color filters, the resolution of the color sequential liquid crystal display 10 can be three times of that of the traditional liquid crystal display with color filters, when the size of the color sequential liquid crystal display 10 is the same as that of the traditional liquid crystal display. Therefore, the color sequential liquid crystal display is highly regarded. However, the color sequential liquid crystal display is configured to use the color sequential method and many light emitting diodes (LEDs) to display color images. As a result, color break-up is easily produced in the image displayed by the color sequential liquid crystal display.

Under ideal conditions, the light of each of three color-fields of a moving picture can be projected on the same location of a viewer's retina, wherein the location corresponds to a pixel of the color sequential liquid crystal display. Therefore, the color information of the pixel can be calculated by continuous integration of the three color-fields over time. When the viewer looks at the moving picture, the viewer's eyes track the moving picture along the direction of the moving object in the moving picture. Therefore, the viewer may see the color break-up on the screen of the color sequential liquid crystal display, such as many color bars around the edge of the moving object.

Therefore, the color break-up may lower the image quality. In addition, when watching the color sequential liquid crystal display for a long time, the viewer may feel dizzy because of the color break-up.

### BRIEF DESCRIPTION OF THE DRAWINGS

FIG. 1 is an exploded, perspective, schematic view of a known color sequential liquid crystal display;

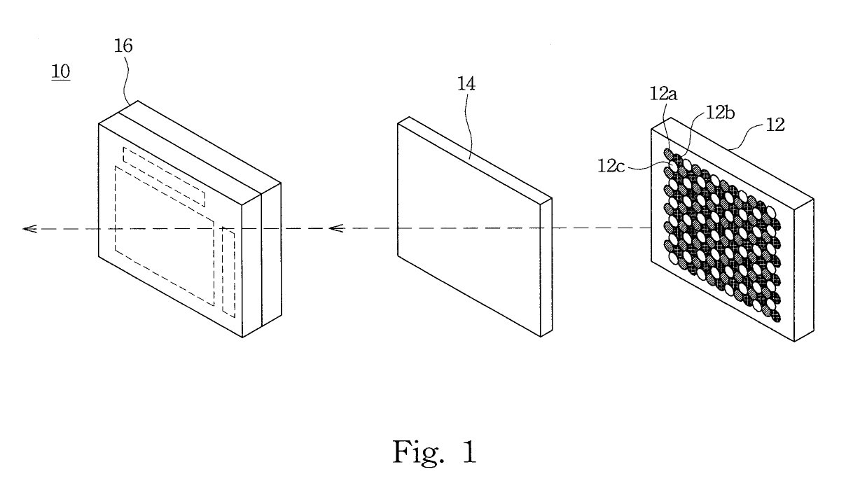

FIG. 2 is an exploded, perspective, schematic view of a liquid crystal panel shown in FIG. 1;

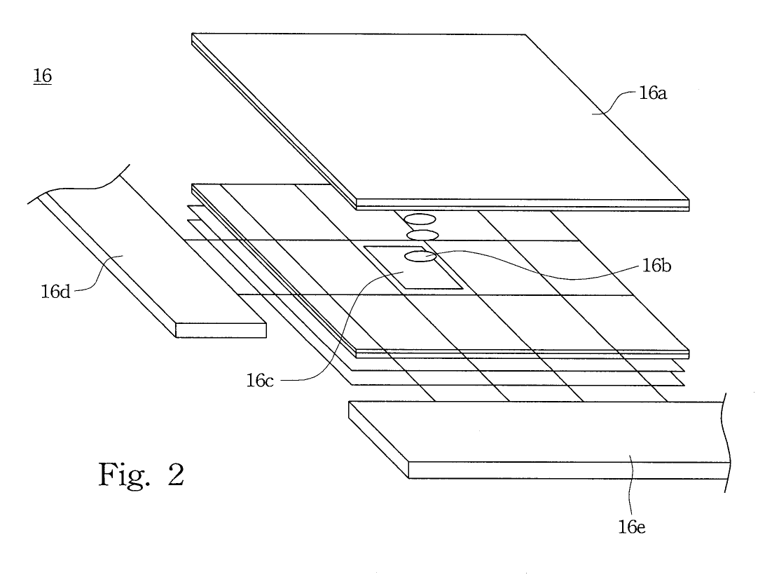

FIG. 3 shows time sequence diagrams of ON times of backlight sources according to one or more embodiments;

FIG. 4 is a flow chart showing a method of driving a backlight module including the backlight sources having the ON times shown in FIG. 3;

FIG. 5 shows time sequence diagrams of ON times of backlight sources according to one or more embodiments;

FIG. 6 is a flow chart showing the method of driving a backlight module including the light sources having the ON times shown in FIG. 5;

FIG. 7 shows liquid crystal transmission ratio curves according to one or more embodiments; and

FIG. 8 is a functional block diagram showing a color sequential liquid crystal display in accordance with one or more embodiments.

### DETAILED DESCRIPTION OF EMBODIMENTS

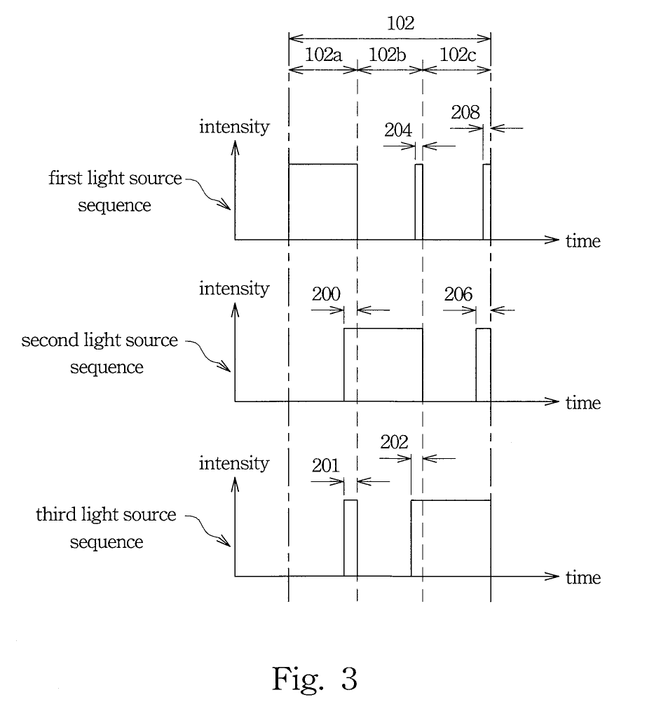

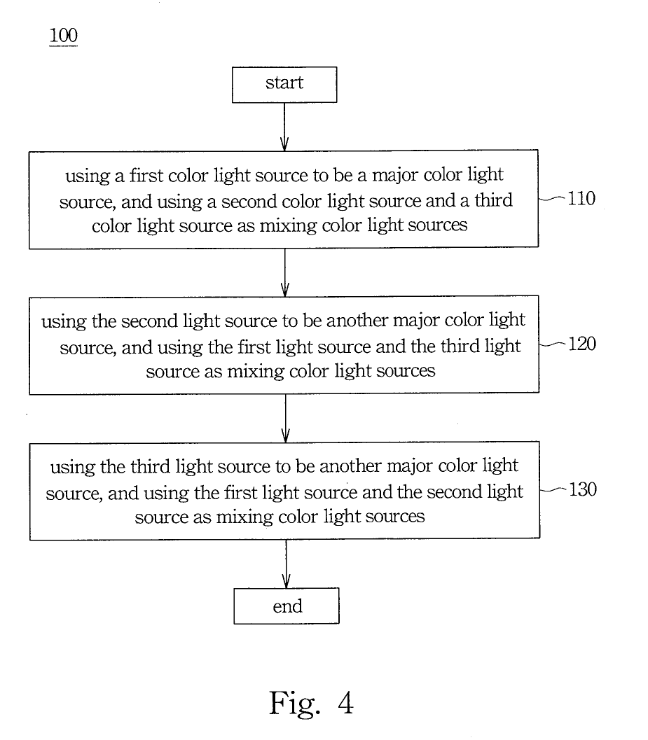

FIG. 3 includes time sequence diagrams of ON times of backlight sources according to one or more embodiments. FIG. 4 is a flow chart showing a method 100 for driving a backlight module including the backlight sources having the ON times disclosed in FIG. 3, wherein the light emitted by each of the light sources has a predetermined intensity value. In FIG. 3, a frame period 102 corresponds to a frame of an image and stands for the time required by a color sequential liquid crystal using the light sources to display a frame. The frame period 102 can be divided into three sub-frame periods 102a, 102b, and 102c. In the method 100, a first major color-controlling step 110 is performed to use a first light source of the backlight module to be a major color light source. In the first major color-controlling step 110, the first light source of the backlight module is controlled to emit a first color light in the sub-frame period 102a, for example, a red light. Therefore, the sub-frame period 102a is a first color sub-frame period used for displaying the first color. A second light source of the backlight module is controlled as a mixing color light source to emit a second color light in a color overlap period 200 of the sub-frame period 102a, for example, a green light. A third light source of the backlight module is controlled as another mixing color light source to emit a third color light in a color overlap period 201 of the sub-frame period 102a, for example, a blue light. The color overlap period 201, in some embodiments, is equal to the color overlap period 200. In one or more embodiments, in the sub-frame period 102a, the backlight module emits the first color light in the whole sub-frame period 102a, and emits the second and third color light in small color overlap periods 200, 201 just before the end of the sub-frame period 102a.

Thereafter, a second major color-controlling step 120 is performed to use the second light source to be another major color light source. In the second major color-controlling step 120, the second light source is controlled to emit the second color light in the sub-frame period 102b. Therefore, the sub-frame period 102b is a second color sub-frame period used for displaying the second color. The third light source is controlled as another mixing color light source to emit the third color light in a color overlap period 202 of the sub-frame period 102b. The first light source is controlled as another mixing color light source to emit the first color light in a color overlap period 204 of the sub-frame period 102b. In one or more embodiments, in the sub-frame period 102b, the backlight module emits the second color light in the whole sub-frame period 102b, and emits the first and third color light in small color overlap periods 202, 204 just before the end of the sub-frame period 102b. In the specific embodiment disclosed in FIG. 3, the color overlap period 202 is greater than the color overlap period 204.

Then, a third major color-controlling step 130 is performed to use the third light source to be another major color light source. In the third major color-controlling step 130, the third light source is controlled to emit the third color light in the sub-frame period 102c. Therefore, the sub-frame period 102c is a third color sub-frame period used for displaying the third color. The second light source is controlled as another mixing color light source to emit the second color light, in a color overlap period 206 of the sub-frame period 102c. The first light source is controlled as another mixing color light source to emit the first color light, in a color overlap period 208 of the sub-frame period 102c. In one or more embodiments, in the sub-frame period 102c, the backlight module emits the third color light in the whole sub-frame period 102c, and emits the second and first color light in small color overlap periods 206, 208 period just before the end of the sub-frame period 102c. In the specific embodiment disclosed in FIG. 3, the color overlap period 206 is greater than the color overlap period 208.

According to the above description, the red light source (first light source) is turned on in the whole first sub-frame period 102a, and also turned on in small color overlap periods 204, 208 in the second sub-frame period 102b and the third sub-frame period 102c, respectively. This embodiment needs a lesser number of red light emitting diodes (LEDs) to attain the same red light brightness as in the known color sequential liquid crystal display. Similarly, the green light source (second light source) and the blue light source (third light source) are turned on in each of the sub-frame periods, to increase the brightness of the green light and blue light, so that this embodiment also needs a lesser number of green and blue light emitting diodes (LEDs) to attain the same green light brightness and blue light brightness as in the known color sequential liquid crystal display.

According to the above description, each of the light sources is turned on in each of the major color periods, so that no color completely disappears in each of the major color periods, and, therefore, the color break up can be suppressed.

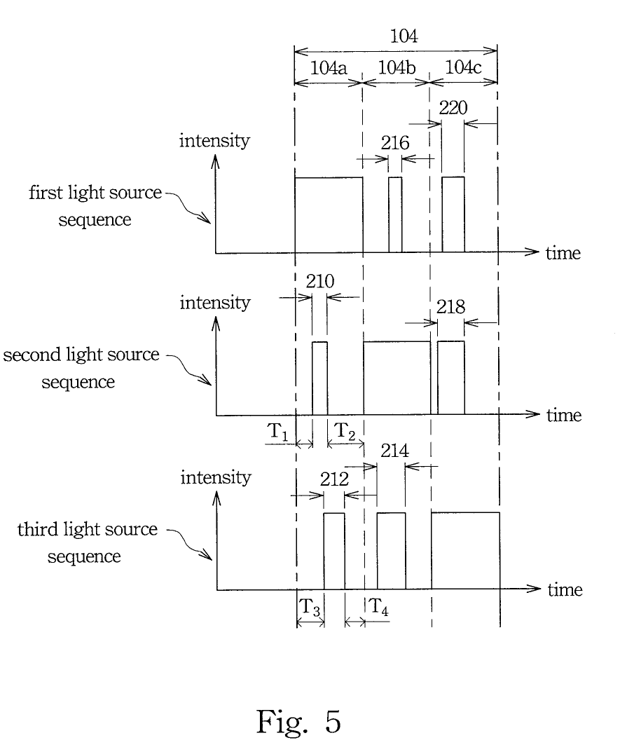

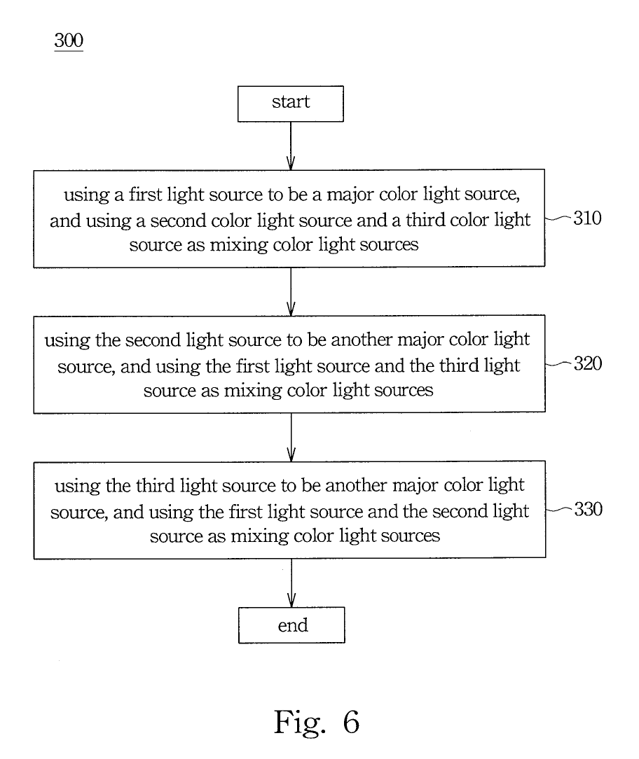

FIG. 5 includes time sequence diagrams of ON times of backlight sources according to in one or more embodiments. FIG. 6 is a flow chart showing a method 300 for driving a backlight module including the light sources having the ON times disclosed in FIG. 5. In FIG. 5, a frame period 104 corresponds to a frame of the image, and divided into three sub-frame periods 104a, 104b, and 104c. In the method 300, a first major color-controlling step 310 is performed to use a first light source of the backlight module to be a major color light source. In the first major color-controlling step 310, the first light source of the backlight module is controlled to emit a first color light in the sub-frame period 104a, for example, a red light. Therefore, the sub-frame period 104a is a first color sub-frame period used for displaying the first color. A second light source of the backlight module is controlled as a mixing color light source to emit a second color light in a color overlap period 210 of the sub-frame period 104a, for example, a green light. A third light source of the backlight module is controlled as another mixing color light source to emit a third color light in a color overlap period 212 of the sub-frame period 104a, for example, a blue light. In one or more embodiments, in the sub-frame period 104a, the backlight module emits the first color light in the whole sub-frame period 104a, and emits the second and third color light in small color overlap periods 210, 212 in the middle of the sub-frame period 104a. In the specific embodiment disclosed in FIG. 5, the color overlap period 212 is greater than the color overlap period 210, and also overlaps without completely encompassing the color overlap period 210.

Thereafter, a second major color-controlling step 320 is performed to use the second light source to be another major color light source. In the second major color-controlling step 320, the second light source is controlled to emit the second color light in the sub-frame period 104b. Therefore, the sub-frame period 104b is a second color sub-frame period used for displaying the second color. The third light source is controlled as another mixing color light source to emit the third color light in a color overlap period 214 of the sub-frame period 104b. The first light source is controlled as another mixing color light source to emit the first color light in a color overlap period 216 of the sub-frame period 104b. In one or more embodiments, in the sub-frame period 104b, the backlight module emits the second color light in the whole sub-frame period 104b, and emits the first and third color light in small color overlap periods 214, 216 in the middle of the sub-frame period 104b. In the specific embodiment disclosed in FIG. 5, the color overlap period 214 is greater than the color overlap period 216, and also overlaps the color overlap period 210. It is not excluded that the color overlap period 214 completely encompasses the color overlap period 216.

Then, a third major color-controlling step 330 is performed to use the third light source to be another major color light source. In the third major color-controlling step 330, the third light source is controlled to emit the third color light in the sub-frame period 104c. Therefore, the sub-frame period 104c is a third color sub-frame period used for displaying the third color. The second light source is controlled as another mixing color light source to emit the second color light, in a color overlap period 218 of the sub-frame period 104c. The first light source is controlled as another mixing color light source to emit the first color light, in a color overlap period 220 of the sub-frame period 104c. In one or more embodiments, in the sub-frame period 104c, the backlight module emits the third color light in the whole sub-frame period 104c, and emits the second and first color light in small color overlap periods 218, 220 of the sub-frame period 104c. In the specific embodiment disclosed in FIG. 5, the color overlap period 218 is greater than the color overlap period 220, and also overlaps the color overlap period 220. It is not excluded that the color overlap period 218 completely encompasses the color overlap period 220.

There are blanking periods T1 and T2 between the color overlap period 210 and the boundaries of the sub-frame period 104a. Because the blanking period of the second color light in the sub-frame period 104a is divided into two blanking periods T1 and T2, the blanking period of the second color light in the sub-frame period 104a becomes un-noticeable to the viewer's eyes. Similarly, there are blanking periods T3 and T4 between the color overlap period 212 and the boundaries of the sub-frame period 104a. Because the blanking period of the third color light in the sub-frame period 104a is divided into two blanking periods T3 and T4, the blanking period of the third color light in the sub-frame period 104a becomes un-noticeable to the viewer's eyes.

According to the above description, a color overlap period is used to divide the blanking period of a mixing color in each of the major color periods into two non-continuous blanking periods to thereby suppress the color break up.

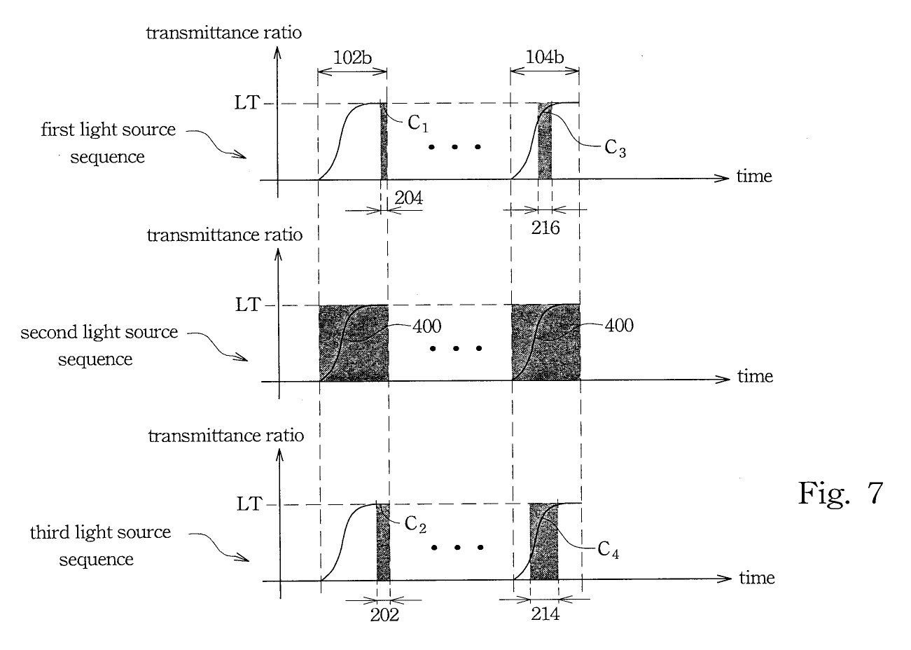

FIG. 7 shows liquid crystal transmission ratio curves according to in one or more embodiments, wherein the shadow area stands for the product of the intensity of the light source and the ON time of the light source. In one or more embodiments, the liquid crystals are turned on and off once in each of the sub-frame periods, and the liquid crystal transmission ratio is increased over time till the liquid crystal transmission ratio attains a predetermined transmission ratio LT. Therefore, each of the color overlap periods corresponds to a transmission ratio curve segment of the liquid crystal transmission ratio curve. For example, in the sub-frame period 102b, the color overlap period 204 corresponds to a transmission ratio curve segment C1, and the color overlap period 202 corresponds to a transmission ratio curve segment C2. Similarly, in the sub-frame period 104b, the color overlap period 216 corresponds to a transmission ratio curve segment C3, and the color overlap period 214 corresponds to a transmission ratio curve segment C4.

Because the brightness of each of the color lights is related to the liquid crystal transmission ratio, in the sub-frame period 102b, the first color brightness is equal to the value calculated by continuous integration of the predetermined intensity of the first color light over the transmittance ratio curve segment C1, and the third color brightness is equal to the value calculated by continuous integration of the predetermined intensity of the third color light over the transmittance ratio curve segment C2. Similarly, in the sub-frame period 104b, the first color brightness is equal to the value calculated by continuous integration of the predetermined intensity of the first color light over the transmittance ratio curve segment C3, and the third color brightness is equal to the value calculated by continuous integration of the predetermined intensity of the third color light over the transmittance ratio curve segment C4.

To avoid the unbalance of the first color brightness in all frame periods, the first color brightness in the sub-frame periods 102b and 104b are the same in some embodiments. By properly adjusting the widths of the color overlap periods 204 and 216, the value calculated by continuous integration can be changed to make the first color brightness in the sub-frame period 102b be the same as that in the sub-frame period 104b. Similarly, by properly adjusting the widths of the color overlap periods 202 and 214, the value calculated by continuous integration can be changed to make the third color brightness in the sub-frame period 102b be the same as that in the sub-frame period 104b. In addition, the intensities of the first color light, the second color light, and the third color light are configured in some embodiments to be the same, so that the calculation of the color brightness can be simplified. However, other arrangements with the first color light and/or the second color light, and/or the third color light having different intensities are not excluded.

It is noted that the above description, which has been presented to show how to attain the balance of the first color brightness and the third color brightness, is also applicable to attain the balance of any of the first, second, third color brightness in any combination thereof.

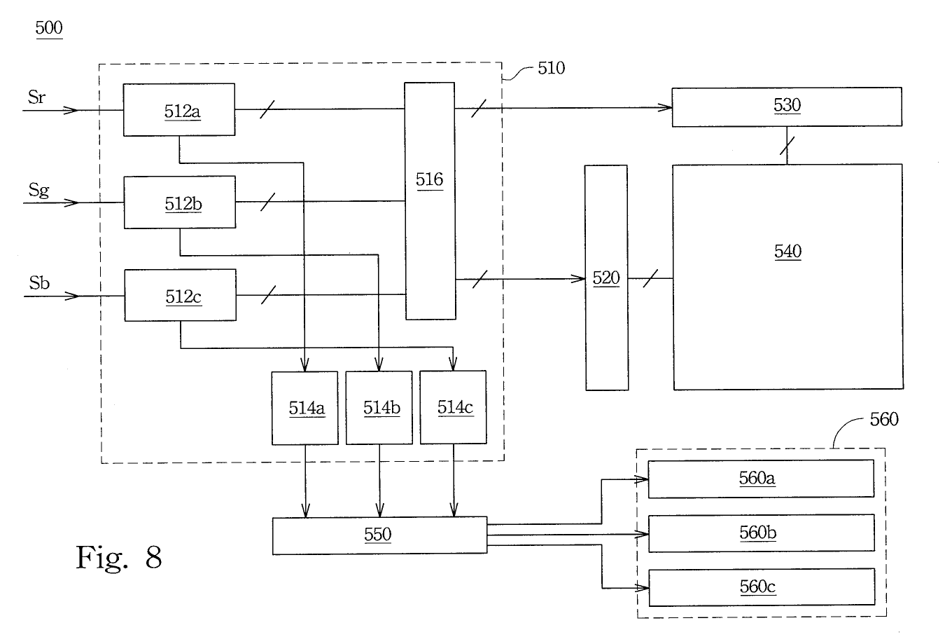

FIG. 8 is a functional block diagram showing a color sequential liquid crystal display 500 in accordance with one or more embodiments. The color sequential liquid crystal display 500 includes a timing controller 510, a gate driver 520, a source driver 530, a liquid crystal panel 540, a light source driving device 550 and light sources 560, wherein the light sources 560 include a red light source 560a, a green light source 560b, and a blue light source 560c. The timing controller 510 is used to control the light source driving device 550 in accordance with a red gray level signal Sr, a green gray level signal Sg, and a blue gray level signal Sb, to drive light sources 560 to emit lights toward the liquid crystal panel 540, and to control the gate driver 520 and the source driver 530 to drive the pixels (not shown in FIG. 8) of the liquid crystal panel 540 to enable the pixels to control the light transmittance ratio to display color images.

The timing controller 510 includes a red color timing control unit 512a, a green color timing control unit 512b, a blue color timing control unit 512c, storage devices 514a, 514b, and 514c, and a transmitting interface 516, wherein the storage device 514a stores a red light pulse width look up table, the storage device 514b stores a green light pulse width look up table, and the storage device 514c stores a blue light pulse width look up table. After receiving the red gray level signal Sr, the red color timing control unit 512a outputs control signals to the storage device 514a, to enable the storage device 514a to select a proper red color pulse width corresponding to the red gray level signal Sr in the red light pulse width look up table. When the red color pulse width is selected, the storage device 514a outputs the red color pulse width to the light source-driving device 550. Similarly, after respectively receiving the green gray level signal Sg and the blue gray level signal Sb, the green color timing control unit 512b and the blue color timing control unit 512c respectively output control signals to the storage devices 514b and 514c, to enable the storage devices 514b and 514c to respectively select a proper green color pulse width corresponding to the green gray level signal Sg in the green light pulse width look up table, and select a proper blue color pulse width corresponding to the blue gray level signal Sb in the blue light pulse width look up table. When the green color pulse width and the green color pulse width are selected, the storage devices 514b and 514c respectively output the green color pulse width and the blue color pulse width to the light source driving device 550. The light source driving device 550 performs the driving method disclosed above with respect to in one or more embodiments according to the red color pulse width, the green color pulse width, and the blue color pulse width, to control the duty cycles and/or ON times of the red color light source 560a, the green color light source 560b, and the blue color light source 560c.

In some embodiments, the storage devices 514a, 514b, 514c are combined into a single storage device (not shown), so that the cost of the display 500 can be decreased.

In one or more embodiments, the ON timing controller 510 comprises a hardware platform, such as a processor or controller chip coupled with a memory, which is programmable by software and/or firmware to perform the functions described herein. In at least some embodiments, controller 510 perform the functions in response to execution of one or more instruction sets comprising the software and/or firmware. Such software comprising instructions for execution resides in a computer-readable medium comprising volatile and/or non-volatile memory, e.g., a random access memory, a read only memory, a programmable memory, a hard disk, a compact disc, or another form of physical storage medium readable, directly or indirectly, by a processing device. In some embodiments, the controller 510 comprises a dedicated hardware circuit, e.g., in form of an application-specific IC (ASIC), hardwired to perform one or more of the processes described herein.

In the disclosed embodiments, the durations of one or more of the ON times of the light sources in each sub-frame period are selected according to the desired color gamut. The color overlap periods in the same sub-frame period may be equal (e.g., 200, 201) or different (e.g., 202, 204). The color overlap periods may be arranged at (e.g., 206) or near (e.g., 218) the beginning or the end of the sub-frame period. The color overlap periods may be also arranged at or near the middle (e.g., 210, 212) of the sub-frame period. The color overlap periods in the same sub-frame period may or may not overlap each other, and if they overlap, one color overlap period may or may not completely encompass the other.

What is claimed is:

1. A method of driving a backlight module comprising a first light source configured to emit a first color light, a second light source configured to emit a second color light, and a third light source configured to emit a third color light, the method of driving the backlight module comprising:
driving the first light source, the second light source, and the third light source respectively and sequentially in a first sub-frame period, a second sub-frame period, and a third sub-frame period of a first frame period so that the backlight module emits predominantly the first color light, the second color light, and the third color light during the first sub-frame period, the second sub-frame period, and the third sub-frame period, respectively; and
controlling the second light source to emit the second color light at a first brightness in a first color overlap period of the first sub-frame period.

2. The method of claim 1, further comprising:
controlling the third light source to emit the third color light at a second brightness in a second color overlap period of the first sub-frame period.

3. The method of claim 2, further comprising:
driving the first light source, the second light source, and the third light source respectively and sequentially in a fourth sub-frame period, a fifth sub-frame period, and a sixth sub-frame period of a second frame period so that the backlight module emits predominantly the first color light, the second color light, and the third color light during the fourth sub-frame period, the fifth sub-frame period, and the sixth sub-frame period, respectively; and
controlling the second light source to emit the second color light at said first brightness in a third color overlap period of the fourth sub-frame period.

4. The method of claim 3, further comprising:
controlling the third light source to emit the third color light at said second brightness in a fourth color overlap period of the fourth sub-frame period.

5. The method of claim 3, wherein the third color overlap period is not equal to the first overlap period.

6. The method of claim 3, wherein the third color overlap period and the first color overlap period are arranged at different relative positions within the first sub-frame period and fourth sub-frame period, respectively.

7. The method of claim 1, wherein the first color overlap period is arranged at the end of the first sub-frame period.

8. The method of claim 1, wherein the first color overlap period is arranged in a middle of the first sub-frame period to define two blanking periods which are arranged between the first color overlap period and boundaries of the first sub-frame period and during which the second light source is turned off.

9. A method of driving a display comprising a plurality of pixels, each of said pixels comprising a liquid crystal layer and a backlight unit, said backlight unit comprising a first light source configured to emit a first color light, a second light source configured to emit a second color light, and a third light source configured to emit a third color light, wherein the first color light, the second color light, and the third color light respectively have a first predetermined intensity, a second predetermined intensity, and a third predetermined intensity, the method of driving the display comprising:
driving the first light source, the second light source, and the third light source respectively and sequentially in a first sub-frame period, a second sub-frame period, and a third sub-frame period of a first frame period so that the backlight unit emits predominantly the first color light, the second color light, and the third color light during the first sub-frame period, the second sub-frame period, and the third sub-frame period, respectively;
respectively controlling a transmittance ratio of the liquid crystal layer in the first sub-frame period, the second sub-frame period, and the third sub-frame period to increase the transmittance ratio over time toward a target transmittance ratio in accordance with a transmittance ratio curve; and
controlling the second light source to emit the second color light at a first brightness in a first color overlap period of the first sub-frame period, wherein the first color overlap period corresponds to a first transmittance ratio curve segment of the transmittance ratio curve, and the first brightness is determined by continuous integration of the second predetermined intensity over the first transmittance ratio curve segment.

10. The method of claim 9, further comprising:
controlling the third light source to emit the third color light at a second brightness in a second color overlap period of the first sub-frame period, wherein the second color overlap period corresponds to a second transmittance ratio curve segment of the transmittance ratio curve, and the second brightness is determined by continuous integration of the third predetermined intensity over the second transmittance ratio curve segment.

11. The method of claim 10, further comprising:
driving the first light source, the second light source, and the third light source respectively and sequentially in a fourth sub-frame period, a fifth sub-frame period, and a sixth sub-frame period of a second frame period so that the backlight unit emits predominantly the first color light, the second color light, and the third color light during the fourth sub-frame period, the fifth sub-frame period, and the sixth sub-frame period, respectively;
respectively controlling the transmittance ratio of the liquid crystal layer in the fourth sub-frame period, the fifth sub-frame period, and the sixth sub-frame period to increase the transmittance ratio over time toward the target transmittance ratio in accordance with the transmittance ratio curve; and
controlling the second light source to emit the second color light at a third brightness in a third color overlap period of the fourth sub-frame period, wherein
the third color overlap period corresponds to a third transmittance ratio curve segment of the transmittance ratio curve,
the third brightness is determined by continuous integration of the second predetermined intensity over the third transmittance ratio curve segment, and
the third brightness is substantially equal to the first brightness.

12. The method of claim 11, further comprising:
controlling the third light source to emit the third color light at a fourth brightness in a fourth color overlap period of the fourth sub-frame period, wherein
the fourth color overlap period corresponds to a fourth transmittance ratio curve segment of the transmittance ratio curve,
the fourth brightness is determined by continuous integration of the third predetermined intensity over the fourth transmittance ratio curve segment, and
the fourth brightness is substantially equal to the second brightness.

13. The method of claim 11, wherein the third color overlap period is not equal to the first overlap period.

14. The method of claim 11, wherein the third transmittance ratio curve segment is different from the first transmittance ratio curve segment.

15. The method of claim 9, wherein one of the first and third transmittance ratio curve segments is shorter than the other and is arranged closer to the end of the respective first or fourth sub-frame period than the other.

16. The method of claim 9, wherein the first, second and third predetermined intensities of the first color light, the second color light, and the third color light are the same.

17. A display, comprising:
a display panel comprising at least a pixel which includes an optical layer having an adjustable transmission ratio;
a backlight module comprising at least a backlight unit corresponding to said pixel, said backlight unit comprising a first light source configured to emit a first color light, a second light source configured to emit a second color light, and a third light source configured to emit a third color light; and
a controller for driving the first light source, the second light source, and the third light source respectively and sequentially in a first sub-frame period, a second sub-frame period, and a third sub-frame period of each frame period so that the backlight unit emits predominantly the first color light, the second color light, and the third color light during the first sub-frame period, the second sub-frame period, and the third sub-frame period, respectively;
wherein said controller is further arranged for controlling at least one of the second and third light sources to emit light of the respective color during the first sub-frame period when the first color light is predominantly emitted.

18. The display of claim 17, wherein
said controller is further arranged for controlling the backlight unit such that none of the first through third colors completely disappear in each of the sub-frame periods.

19. The display of claim 17, wherein
said controller is further arranged for controlling said at least one of the second and third light sources to emit light of the respective color at substantially the same brightness during the first sub-frame periods of multiple frames.

20. The display of claim 17, wherein
said controller is further arranged for controlling, based on the adjustable transmission ratio of the optical layer, said at least one of the second and third light sources to emit light of the respective color at the same brightness during the first sub-frame periods of multiple frames.
